(19) United States
(12) Patent Application Publication
(10) Pub. No.: US 2010/0206150 A1
(43) Pub. Date: Aug. 19, 2010

(54) STAMPING TOOL

(75) Inventors: Stefan Kraft, Schnabelwaid (DE); Andreas Deuerlein, Egloffstein (DE)

Correspondence Address: BROWDY AND NEIMARK, P.L.L.C.;624 NINTH STREET, NW, SUITE 300, WASHINGTON, DC, 20001-5303, US

(73) Assignee: PASS Stanztechnik AG, Creussen (DE)

(21) Appl. No.: 12/576,069

(22) Filed: Oct. 8, 2009

(30) Foreign Application Priority Data
Feb. 19, 2009 (DE) 20 2009 002 418.0

(51) Int. Cl. B26F 1/14; B26D 7/26

(52) U.S. Cl. 83/140; 83/530; 83/686; 83/699.41

(57) ABSTRACT

A stamping tool has a stamping punch for forming at least one punched hole in a workpiece. The stamping punch is guided in a guide housing along a stamping displacement movement. The stamping punch has a stamping element and a head element, which is connected with the stamping element by means of a screw connection. A length of the stamping punch between a head front face and a stamping surface, which closes off the stamping element at the front, can be set by means of the screw-in depth of the screw connection. An unlocking body, which is freely accessible from outside of the guide housing can be displaced between a locked position, in which the screw connection is blocked, and a screwing position, in which the screw connection is released. The result is a stamping tool with a simplified length adjustment.

### FIELD OF THE INVENTION

The invention relates to a stamping tool, having a stamping punch for forming at least one stamped hole in a workpiece, and having a guide housing, in which the stamping punch is guided along a stamping displacement movement.

### BACKGROUND OF THE INVENTION

Such a stamping tool is known from DE 296 09 541 U1.

In the course of the operation of the stamping tool, the stamping punch wears. Stamping punches are known, which have a stamping element and a head element, which is connected with the stamping element via a screw connecting device. It is possible by means of the screw connecting device to provide a length adjustment of the stamping punch between a head-front wall and a punching face which closes off the stamping element at the front wall.

### OBJECT AND SUMMARY OF THE INVENTION

It is the object of the invention to simplify such a length adjustment.

In accordance with the invention, this object is attained by means of a stamping tool having the characteristics disclosed in claim 1.

A freely accessible unlocking body makes it possible to preset the length of the stamping tool without it being necessary for it to be displaced in relation to the guide housing in comparison with its normal operating position. This simplifies the length adjustment and thus reduces unnecessary down times of the stamping tool.

An arresting body in accordance with claim 2 results in a secure blockage of the screw connecting device.

An embodiment in accordance with claim 3 advantageously results in fewer parts for locking, or respectively unlocking the screw connecting device for the length adjustment of the stamping punch.

An unlocking body in accordance with claim 4, which works together with an arresting body, increases the structural degrees of freedom of a freely accessible unlocking of the locked screw connecting device. For example, the displacement of the unlocking body can take place in an axial direction, while the displacement movement of the arresting body can take place in a radial direction.

Pre-tensioning springs in accordance with claims 5 and 6 increase the operational dependency of the stamping tool. It is possible by means of the arresting pre-tensioning spring in accordance with claim 6 to cause a click/snap-in noise in the course of the length adjustment when, because of being pre-tensioned, the respective arresting body makes contact in the course of the turning of the stamping tool toward the head element. Each click can provide the user with an acknowledgement that he has adjusted the length of the stamping punch by a further increment.

Arrestment receptacles in accordance with claim 7 can be designed in a constructively simple manner.

A plurality of arrestment receptacles in accordance with claim 8 allows a highly precise length adjustment in case of a preset pitch of a screw thread of the length adjustment screw connecting device. The arrestment receptacles are in particular embodied in a circumferential wall of the stamping element, or of the head element.

An unlocking slide in accordance with claim 9 is an unlocking body which can be comfortably operated.

This correspondingly applies to an arrestment body in accordance with claim 10.

It is a further object of the invention to simplify an exchange of the stripper body.

In accordance with the invention, this object is attained by a stamping tool having the characteristics disclosed in claim 11.

The unlocking slide results in the unlocking, comfortably accessible from the outside, of the stripper body, which can then be removed from the guide housing and exchanged for another stripper body, for example. The stamping tool with the stripper body which can be unlocked by means of the unlocking body can also have the characteristics discussed at the outset in connection with the unlocking body.

An interruption section in accordance with claim 12 leads to a constructively simple attainment of a securing ring which can be shifted between a securing and an unlocking position.

The securing bodies in accordance with claims 13 and 14 are easy to construct and result in a dependable widening of the interruption section of the securing ring.

Pre-tensioning springs in accordance with claims 15 and 16 again increase on the one hand the operational dependability, and on the other hand the ease of operating the stamping tool.

An unlocking slide in accordance with claim 17 is comfortable to operate.

### BRIEF DESCRIPTION OF THE DRAWINGS

Exemplary embodiments of the invention will be explained in greater detail in what follows by means of the drawings. Shown are in:

FIG. 1, perspectively a first embodiment of a stamping tool with an unlocking slide for an arresting body for arresting a screw connection for setting a stamping punch length, and with an unlocking slide for a securing ring for a stripper body, wherein the stamping tool is represented without a guide housing and without the stripper body,

FIG. 2, a section through a stamping tool in accordance with FIG. 1 with an additionally represented guide housing and stripper body, wherein the sectional plane extends centered through the two slides,

FIG. 3, a section in accordance with the line III-III in FIG. 2,

FIG. 4, an exploded view of a further embodiment of a stamping tool with an unlocking slide, wherein a lower tool element is additionally represented,

FIG. 5, a lateral view of an assembled stamping tool in accordance with FIG. 4 with the lower tool element, and

FIG. 6, a section in accordance with line VI-VI in FIG. 5.

### DETAILED DESCRIPTION OF THE PREFERRED EMBODIMENTS

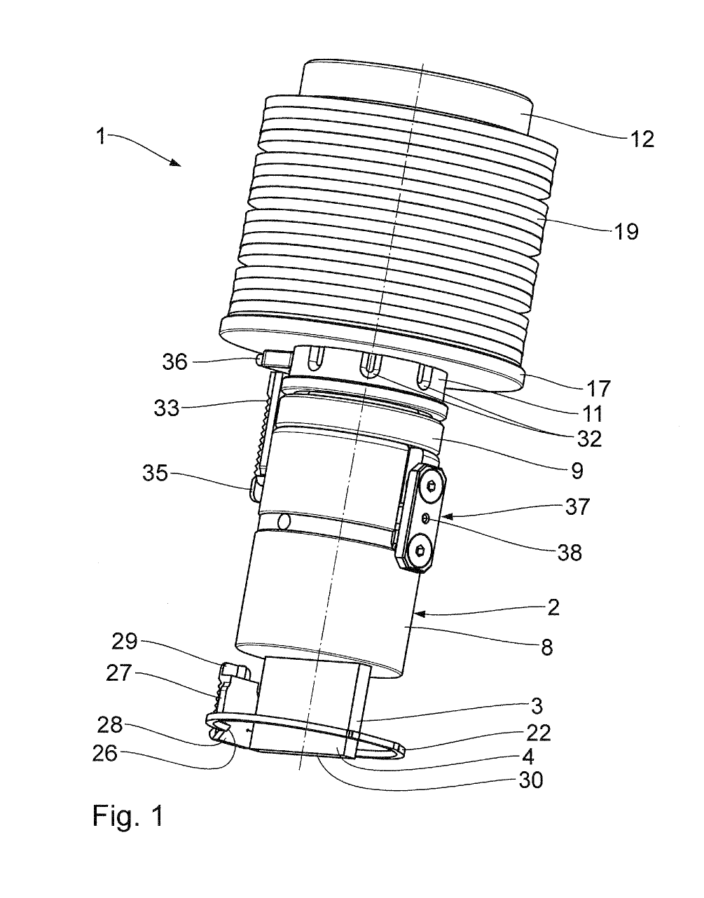

A stamping tool 1 in the embodiment in accordance with FIGS. 1 to 3 has a stamping punch 2 for forming at least one punched hole in a workpiece. The stamping punch 2 has a stamping element 3 with the stamping section 4, which comes into contact with the actual workpiece, and a head element 5, which is connected with the stamping element 3 by means of a screw connection 6.

Perpendicularly in relation to a longitudinal shaft 7 of the stamping tool 1, the stamping section 4 has a cross section corresponding to the cross section of the punched hole to be made. In the embodiment in accordance with FIGS. 1 to 3, this cross section is rectangular. Depending on the desired external shape of the punched hole, the stamping section 4 can of course also have a different, for example round, square, oval cross section, or also a special shape of a cross section, for example star-shaped.

In turn, the stamping element 3 and the head element 5 are each made of several pieces. Besides a punch body 8, whose one-piece component is the stamping section 4, the stamping element 3 also has a punch adapter 9, which is arranged facing the head element 5. The punch body 8 and the punch adapter 9 are fixedly screwed together by means of a cap screw 10 extending along the longitudinal shaft 7. An exterior jacket wall of the punch adapter 9 has an exterior screw thread of the screw connection 6.

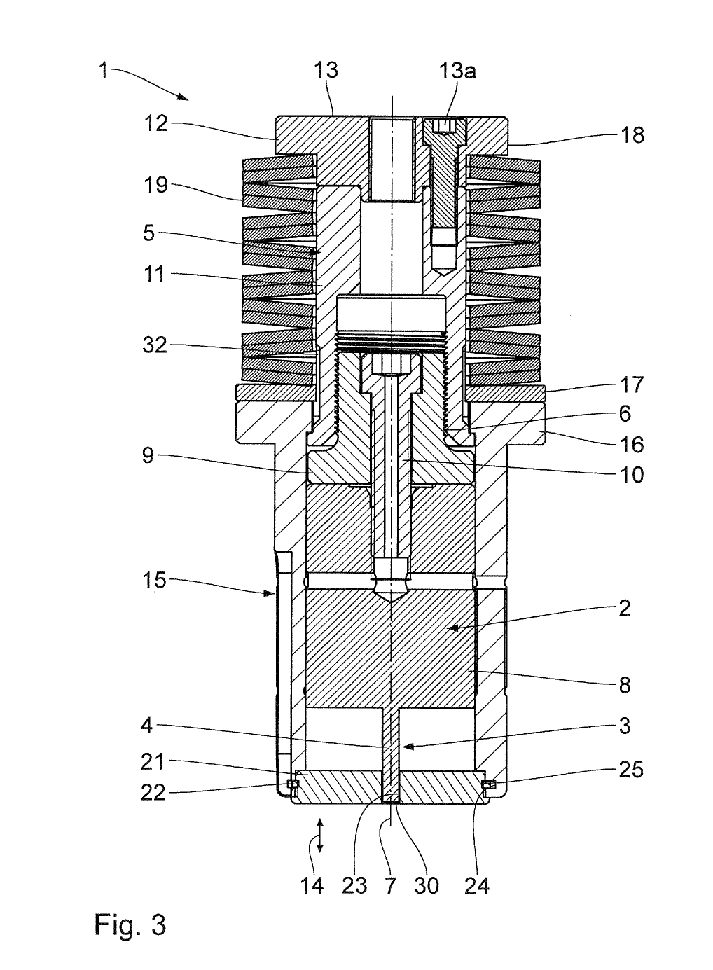

The head element 5 comprises a punch driver 11, facing the stamping element, and a punch head element 12 with a head surface 13, which is acted upon from the direction of the stamping device in which the stamping tool 1 is housed. The punch head element 12 and the punch driver 11 are screwed together by means of further cap screws 13a (see FIG. 3). An interior jacket wall has an interior screw thread of the screw connection 6.

A length of the stamping punch 2 between the head front face 13 and a stamping surface 30, which closes off the stamping section 4 at the front, i.e. is located opposite the stamping element 3, can be set by means of a screw-in depth of the screw connection 6.

The stamping punch 2 is guided along a stamping displacement movement (see 14) extending parallel to the longitudinal shaft 7 in a guide housing 15 of the stamping tool 1. A disk ring 17 rests on a circumferential collar 16 on the head of the guide housing 15. A stamping pressure spring 19, embodied as a disk spring package, is supported between the ring 17 and a circumferential collar 18 of the punch head element 12. In the position of rest represented in FIGS. 1 to 3, the stamping pressure spring 19 provides a pre-tensioning of the stamping tool. In this position the stamping element 4 is retracted for some tenths of a millimeter behind an end strip-off face 20 of a stripper body 21. A stripper body pre-tensioning spring, not represented, provides a pre-tensioning of the stripper body 21, so it is in a position in which it is free of the guide housing 15.

The stripper body 21 is fixed in place on the guide housing 15 and secured on it by securing means in the form of a securing ring 22. The stripper body 21 has a stripper opening 23 design to complement the cross section of the stamping section 4, through which the stamping section 4 is conducted. On one side, the securing ring 22 rests in an interior circumferential groove 24 of an end section at the front, and on the other side in an exterior circumferential groove 25 of the stripper body 21. The securing ring (see FIG. 1) is interrupted by an interruption section 26, i.e. it is embodied in the manner of a snap ring. An unlocking body in the form of an unlocking slide 27 is guidedly arranged in a section on the strip-off side of an exterior wall of the guide housing 15. The unlocking slide 27 works together with the securing ring 22 and can be displaced between a securing position, represented in FIGS. 1 to 3, in which the unlocking slide 27 is arranged in such a way that the securing ring 22 secures the stripper body 21 on the guide housing 15, and an unlocking position, in which the unlocking slide 27 is arranged in such a way that the securing ring 22 releases the stripper body 21 from the guide housing 15. The unlocking slide 27 has a double wedge section in the form of a dovetailed section 28, which enters into the interruption section 26 of the securing ring 22. The dovetailed section 28 widens toward the end strip-off face 20 of the stripper body 21. An unlocking body pre-tensioning spring 29, which is supported between the unlocking slide 27 and a circumferential step in the guide housing 15, provides the pre-tensioning of the unlocking slide 27 in the securing position.

An arresting body 31 for the screw connection 6 is fixed in place on the guide housing 15. The arresting body 31 can be displaced between an arresting position, represented in FIGS. 1 to 3, in which the arresting body 31 engages an arresting receptacle 32 in a jacket wall of the punch driver 11 to block the screw connection 6, and a release position, in which the arresting body 31 is snapped out of the arresting receptacle 32 for releasing the screw connection 6. In total, the punch driver 11 has a plurality of arresting receptacles 32 (see FIG. 1), which are formed in the circumferential direction around the punch driver 11, i.e. distributed around the stamping punch 2, in its jacket wall. The arresting receptacles 32 are designed as receiving grooves extending along the longitudinal shaft 7 of the stamping tool 1. The arresting receptacles 32 are embodied in the head element 5 of the stamping punch 2.

An unlocking body in the form of an unlocking slide 33 is arranged adjacent to the arresting body 31 in the exterior wall of the guide housing 15. The slide 33 can be displaced, guided parallel in relation to the longitudinal shaft 7, between a locking position represented in FIGS. 1 to 3, in which the unlocking body 33 enters into a locking receptacle 34 in the arresting body 31 for fixing the arresting body 31 in the arrested position, and an unlocking position, in which the unlocking slide 33 is disengaged from the arresting position into the release position for releasing a displacement of the arresting body 31 from the arresting position into the release position.

The unlocking slide 33 is pre-tensioned in the locking position by means of an unlocking body pre-tensioning spring 35. The unlocking body pre-tensioning spring 35 is supported between an axial step in the guide housing 15 and the unlocking slide 33. The arresting body 31 is pre-tensioned in the arresting position by means of an arresting body pre-tensioning spring 36. The arresting body pre-tensioning spring 36 is supported between a radial step in the guide housing 15 and in the arresting body 31.

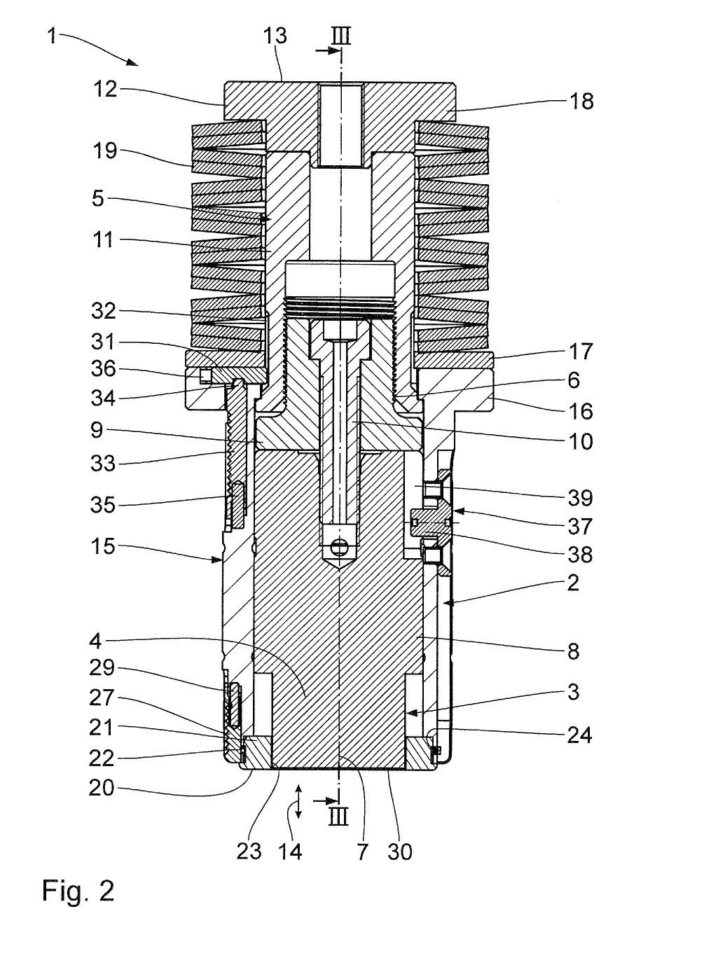

An adjustment in length of the stamping punch 2 takes place as follows: the unlocking slide 33 in FIG. 2 is manually displaced downward, for example by the thumb, against the pre-tensioning force of the unlocking body pre-tensioning spring 35, so that the unlocking slide 33 is released from the locking receptacle 34 in the arresting body 31. It is now possible to screw the head element 5 relative to the stamping element 3, i.e. the screw connection 6 is released. In the course of turning, the arresting body 31 is displaced toward the left in FIG. 2 and in this way comes free of the arresting receptacle 32. A clicking, or respectively snap-in noise is generated by displacing the arresting body 31 in the course of turning the head element 5 in relation to the stamping element 3. This snap-in noise results from the contact of the arresting body 31 with the arrestment receptacles, which follow each other in sequence in the circumferential direction around the longitudinal shaft 7, into which the pressure spring 36 respectively pushes the arresting body. Each click in the course of turning the head element 5 relative to the stamping element 3 indicates to the user that the length of the stamping punch 2 has been changed by one increment, in the instant exemplary embodiment by 0.2 mm. The increment of 0.2 mm in the instant exemplary embodiment results from the pitch of the threads of the screw connection 6 of 1.6 mm and from the fact that a total of eight arresting receptacles 32 are evenly distributed in the circumferential direction of the longitudinal shaft 7. Now the user can grasp the punch head element 12 and rotate it around the longitudinal shaft 7 in relation to the stamping element 3. By means of the screwing movement of the screw connection 6 occurring in the course of this, a change in length of the stamping punch 2 between the head front face 13 and the stamping surface 30 now takes place. Since the axial position of the head element 5 in the guide housing 15 is fixed because of a corresponding positive connection, the relative axial position of the stamping element 3 changes in the guide housing 15 because of this screwing process and it is then possible to set the axial position of the stamping surface 30 relative to the end strip-off face 20. As soon as the correct length, i.e. a predetermined retraction of the stamping surface 30 behind the end strip-off face 20 has been achieved, the unlocking slide 33 is released, and the punch head element 12 is still rotated until the arresting body 31 moves into the next following arresting receptacle 32 because of being pre-tensioned by the pre-tensioning spring 36. As soon as the arresting body 31 has again assumed its arresting position, the unlocking slide 33 again automatically enters into the locking receptacle 34 because of pre-tensioning of the unlocking body pre-tensioning spring 35, which is also embodied as a pressure spring. Then the preset length of the stamping punch 2 is secured.

In connection with a rotationally-symmetrical design of the stamping section 4, a twist-prevention device 37 assures that the stamping element 3 does not rotate along in an undesirable manner around the longitudinal shaft 7 in the course of turning the punch head element 12 for longitudinal adjustment. The twist-prevention device 37 is comprised of a guidance wedge 38, which is screwed into the guide housing 15 and enters into an axial groove 39 in an exterior jacket wall of the punch body 8.

For exchanging the stripper body 21, the unlocking slide 27 is upwardly displaced against the pre-tensioning force of the unlocking body pre-tensioning spring 29 into the unlocking position. In the unlocking position, the wedge sections of the dovetailed section 28 of the unlocking slide 27 force the two ends of the securing ring 22, which define the interruption section 26 and are located opposite each other, apart, whose circumference is thus increased. The securing ring 22 then enters deeper into the interior circumferential groove 24 of the guide housing 15 until the securing ring 22 is free of the exterior circumferential groove 25 of the stripper body 21. Because of pre-tensioning by means of the non-represented stripper body pre-tensioning spring, the stripper body 21 is then expelled downward in FIGS. 2 and 3.

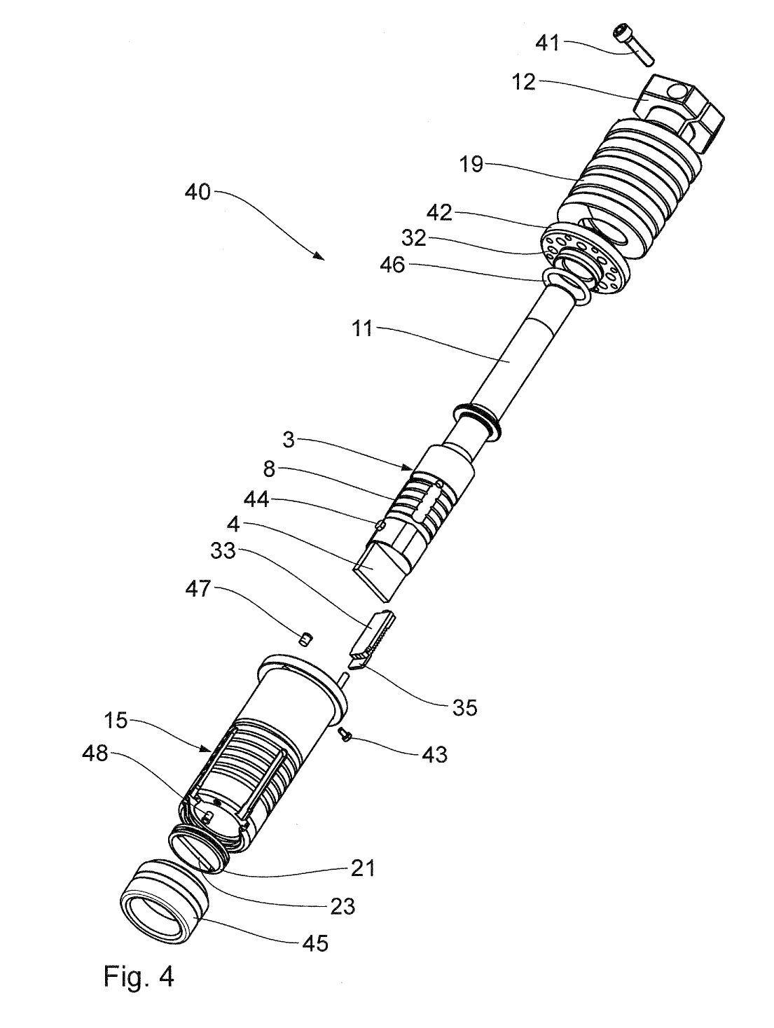

A further embodiment of the stamping tool will be explained in what follows by means of FIGS. 4 to 6. Components corresponding to those already described above by reference to FIGS. 1 to 3 have the same reference numerals and will not be discussed again in detail.

In the embodiment of FIGS. 4 to 6, the stamping pressure spring 19 is embodied as a helical spring.

The punch head element 12 with the punch driver 11 is fixed in place in the stamping tool 40 by means of a clamping cap screw 41.

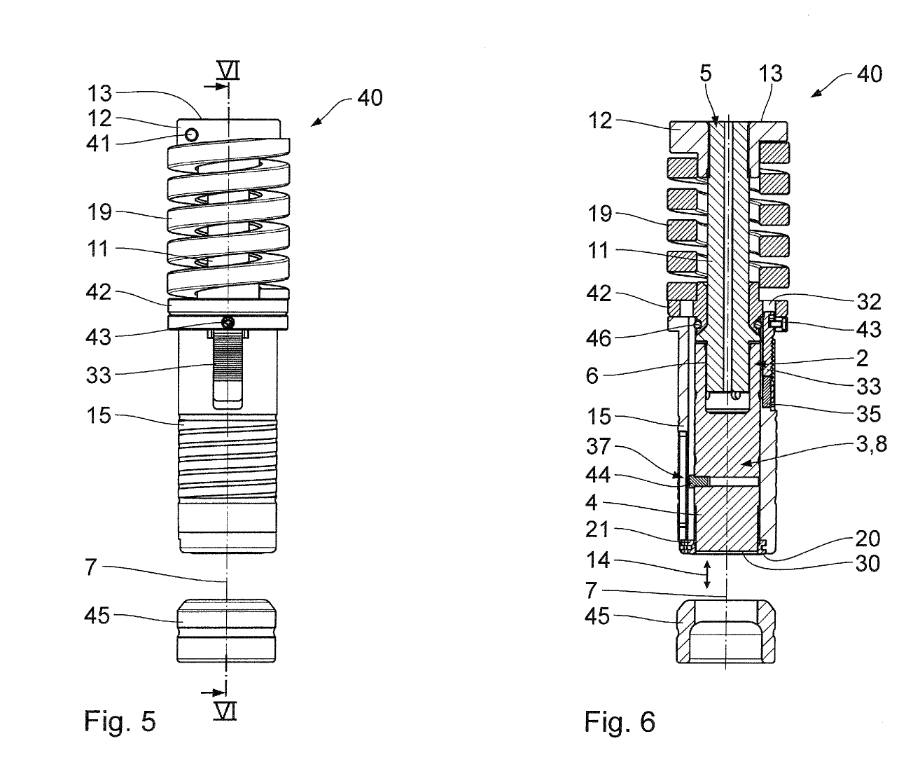

The unlocking slide 33 of the stamping tool 40 also has the function of the arresting body of the stamping tool 1 in accordance with FIGS. 1 to 3. In the locking position of the unlocking slide 33 represented in FIGS. 5 and 6, a section of the unlocking slide 33 located opposite the unlocking body pre-tensioning spring 35 engages one of a plurality of arresting receptacles 32, which in the stamping tool 40 are embodied as axial through-bores in a annular cover 42 of the stamping tool 40. In the stamping tool 40 the arresting receptacles 32 are also arranged evenly distributed around the longitudinal shaft 7 in the circumferential direction.

In the stamping tool 40, the stamping pressure spring 19 is supported between an exterior circumferential collar of the punch head element 12 and the annular cover 42.

A cap screw 43, which has been radially screwed from the outside in a circumferential collar of the cover of the guide housing 15, secures the unlocking slide 33 in the locking position, in which the unlocking slide 33 is again pre-tensioned by means of the unlocking body pre-tensioning spring 35 embodied as a pressure spring. The cap screw 43 engages an axial, i.e. extending parallel in relation to the longitudinal shaft 7, groove in the unlocking slide 33 of the stamping tool 40.

The annular cover 42 is connected, fixed against relative rotation, in a non-positive manner with the punch driver 11.

An O-ring 46, serving to make assembly easier, has been inserted between a circumferential collar of the annular cover 42 extending past the guide housing 15 and the guide housing 15 itself.

In the course of assembling the stamping tool 40, the guide housing 15 is pushed with a force of approximately 2 kg onto the punch body 8. An annular groove in the guide housing 15 containing the O-ring 46 then secures the former against undesired slipping, for example during transport of the stamping tool 40.

Moreover, the O-ring 46 has the task of permitting a rotation between the guide housing and the head element in the course of the length adjustment, while these components remain axially secured to each other.

In the stamping tool 40, the twist-prevention device 37 is embodied in the form of a guide pin 44 inserted into the punch body 8 and engages an axially extending longitudinal groove in the guide housing 15.

In addition, a lower tool part 45, arranged below the guide housing, is represented in the stamping tool 40. In the course of operating the stamping tool 40, the workpiece is inserted between the end strip-off face 20 and the lower tool part 45.

With the stamping tool 40, a length adjustment of the stamping punch 2 takes place in the following manner: the unlocking slide 33 in FIG. 6 is manually displaced downward, for example by the thumb, against the pre-tensioning force of the unlocking body pre-tensioning spring 35, into the unlocking, or respectively the screwing position, in which the unlocking slide 33 moves out of the arresting receptacle 32 in the annular cover 42. It is now possible to turn the punch head element 12, together with the punch driver 11 and the annular cover 42, around the longitudinal shaft 7, so that a screwing actuation of the screw connection 6 takes place. Because of the twist-prevention device 37, the punch body 8 does not rotate along in an undesired manner. Then, with the unlocking slide 33 disengaged, a length adjustment of the stamping punch 2 is performed, such as already previously explained in connection with the embodiment in accordance with FIGS. 1 to 3. Following the length adjustment, the unlocking slide 33 is released. Then the turning of the punch head element 12 is continued until the unlocking slide 33 enters into the arresting receptacle 32 next on the circumference under the pre-tensioning by the unlocking body pre-tensioning spring 35. The predetermined longitudinal setting of the stamping punch 2 is then assured.

A spring-loaded spherical pressure element 47 introduced into a front face of the guide housing 15 facing the annular cover 42 (see the exploded view in accordance with FIG. 4) provides the clicking/snap-in noise in the course of the longitudinal adjustment of the stamping tool 40 in a manner corresponding to what was explained in connection with the stamping tool 1 in accordance with FIGS. 1 to 3.

For security during transport, a further spring-loaded spherical pressure element 48 has been inserted into the oppositely-located front wall of the guide housing 15.

1. A stamping tool (1, 40),
having a stamping punch (2) for forming at least one punched hole in a workpiece,
having a guide housing (15), in which the stamping punch (2) is guided in the former along a stamping displacement movement (14),
wherein the stamping punch (2) has
a stamping element (3),
a head element (5), which is connected with the stamping element (3) by means of a screw connection (6),
wherein a length of the stamping punch (5) between a head front face (13) and a stamping surface (30) which closes off the stamping element (3) at the front can be set by means of the screw-in depth of the screw connection (6),
wherein an unlocking body (33), which is freely accessible from outside of the guide housing (15) can be displaced between
a locked position, in which the screw connection (6) is blocked, and
a screwing position, in which the screw connection (6) is released.

2. The stamping tool in accordance with claim 1, characterized in that an arresting body (31) fixed in place on the guide housing (15) can be displaced between
an arresting position, in which the arresting body (31) engages an arresting receptacle (32) in a jacket wall of the stamping punch elements (3, 5) for blocking the screw connection (6),
a release position, in which the arresting body (31) has been removed out of the arresting receptacle (32) for releasing the screw connection.

3. The stamping tool in accordance with claim 2, characterized in that the unlocking slide (33) is at the same time the arresting body.

4. The stamping tool in accordance with claim 2, characterized in that the unlocking body (33) is arranged on an exterior wall of the guide housing (15) and can be displaced between
the locking position, in which the unlocking body (33) engages a locking receptacle (34) in the arresting body (31) for fixing the arresting body (31) in place in the arresting position,
the screw-unlocking position, in which the unlocking body (33) is moved out of the locking receptacle (34) for releasing a displacement of the arresting body (31) from the arresting position into the screw-release position.

5. The stamping tool in accordance with claim 1, characterized by an unlocking body pre-tensioning spring (35), which pre-tensions the unlocking body in the locking position.

6. The stamping tool in accordance with claim 2, characterized by an arresting body pre-tensioning spring (36), which pre-tensions the arresting body (31) in the arresting position.

7. The stamping tool in accordance with claim 2, characterized in that the at least one arresting receptacle (32) is embodied in the head element (5) of the stamping punch (2).

8. The stamping tool in accordance with claim 2, characterized by a plurality of arresting receptacles (32), which are arranged distributed around the stamping punch (2) in the circumferential direction.

9. The stamping tool in accordance with claim 1, characterized in that the unlocking body is embodied as an unlocking slide.

10. The stamping tool in accordance with claim 2, characterized in that the arresting body is embodied as an unlocking slide.

11. A stamping tool (1),
having a stamping punch (2) for forming at least one punched hole in a workpiece,
having a guide housing (15), in which the stamping punch (2) is guided in the former along a stamping displacement movement (14),
having a stripper body (21) fixed in place on the guide housing (15) and secured on it by securing means (22) and with a stripper opening (23) embodied complementary to the cross section of a stamping section (4) of the stamping punch (2), through which the stamping section (4) is conducted,
wherein the securing means (22) are designed in the form of a securing ring interrupted by an interruption section (26),
wherein an unlocking body (27) is arranged in an exterior wall of the guide housing (15), is freely accessible from outside of the guide housing (15), works together with the securing ring (22) and can be displaced between
a securing position, in which the unlocking body (27) is arranged in such a way that the securing ring (22) secures the stripper body (21) on the guide housing (15),
an unlocking position, in which the unlocking body (27) is arranged in such a way that the securing ring (22) releases the stripper body (21) from the guide housing (15).

12. The stamping tool in accordance with claim 11, characterized in that in the unlocking position the unlocking body (27) widens the interruption section (26), wherein the diameter of the securing ring (22) is increased to release the stripper body (21).

13. The stamping tool in accordance with claim 12, characterized in that the unlocking body (27) has at least one wedge section, which engages the interruption section (26).

14. The stamping tool in accordance with claim 13, characterized in that the unlocking body (27) has a dovetailed section (28, which engages the interruption section (26).

15. The stamping tool in accordance with claim 11, characterized by an unlocking body pre-tensioning spring (29), which pre-tensions the unlocking body (27) in the securing position.

16. The stamping tool in accordance with claim 11, characterized by an stripper body pre-tensioning spring, which pre-tensions the stripper body (21) in the position in which it is released from the guide housing (15).

17. The stamping tool in accordance with claim 11, characterized in that the unlocking body (27) is embodied as an unlocking slide.
